(19) United States
(12) Patent Application Publication
(10) Pub. No.: US 2025/0260083 A1
(43) Pub. Date: Aug. 14, 2025

(54) POWER STORAGE DEVICE AND ELECTRICALLY POWERED VEHICLE

(71) Applicant: TOYOTA JIDOSHA KABUSHIKI KAISHA, Aichi-ken (JP)

(72) Inventors: Masataka OGUSHI, Nisshin-shi (JP); Yutaroh GOTOH, Toyota-shi (JP); Masaya NAKAMURA, Kariya-shi (JP)

(21) Appl. No.: 19/019,307

(22) Filed: Jan. 13, 2025

(30) Foreign Application Priority Data
Feb. 13, 2024 (JP) 2024-019308

(51) Int. Cl. H01M 10/613; B60L 50/60; B60L 50/64; H01M 10/625; H01M 10/6556; H01M 10/6567

(52) U.S. Cl. CPC H01M 10/613; B60L 50/64; B60L 50/66; H01M 10/625; H01M 10/6556; H01M 10/6567

(57) ABSTRACT

A power storage device includes: a plurality of battery cells each having a positive electrode terminal and a negative electrode terminal, each of the plurality of battery cells being arranged side by side in a first direction; and a first cooler and a second cooler each being in contact with each of the battery cells directly or with a thermally conductive member interposed therebetween. The first cooler is located above the second cooler, and the second cooler is located below each of the positive electrode terminals and each of the negative electrode terminals. The first cooler is lower in thermal conductivity than the second cooler.

### CROSS REFERENCE TO RELATED APPLICATIONS

This nonprovisional application is based on Japanese Patent Application No. 2024-019308 filed on Feb. 13, 2024 with the Japan Patent Office, the entire contents of which are hereby incorporated by reference.

### BACKGROUND

### Field

The present disclosure relates to a power storage device and an electrically powered vehicle.

### Description of the Background Art

Conventionally, a power storage device has been mounted in an electrically powered vehicle. For example, Japanese Patent Laying-Open No. 2023-165300 discloses, as an example of a power storage device, a battery pack disposed below a floor panel of a vehicle. The battery pack disclosed in Japanese Patent Laying-Open No. 2023-165300 includes a plurality of battery modules and a battery case that accommodates the plurality of battery modules. The battery case has a lower plate constituting a bottom surface of the battery case. The lower plate is provided with a cooling path through which a coolant flows.

### SUMMARY

When a battery cell is cooled from a plurality of surfaces, the area of the surface of a cooler that is exposed to the outside is larger than that in the case where the battery cell is cooled from one surface. This results in a larger amount of water droplets generated by dew condensation in the cooler. Thus, there is a demand to suppress a short circuit in the power storage device.

The present disclosure provides: a power storage device capable of, even in a case of using a plurality of coolers, suppressing a short circuit resulting from water droplets generated by dew condensation in each of the coolers; and an electrically powered vehicle including the power storage device.

According to an aspect of the present disclosure, a power storage device includes: a plurality of battery cells each having a positive electrode terminal and a negative electrode terminal, the plurality of battery cells being arranged side by side in a first direction; and a first cooler and a second cooler, each of the first cooler and the second cooler being in contact with each of the battery cells directly or with a thermally conductive member interposed therebetween. The first cooler is located above the second cooler, and the second cooler is located below each of the positive electrode terminals and each of the negative electrode terminals. The first cooler is lower in thermal conductivity than the second cooler.

According to the above-described configuration, the first cooler located above the second cooler is lower in thermal conductivity than the second cooler. Dew condensation is less likely to occur in the case of lower thermal conductivity than in the case of higher thermal conductivity. Thus, dew condensation can be caused more preferentially in the second cooler than in the first cooler. Further, the second cooler is located below each of the positive electrode terminals and each of the negative electrode terminals. Thus, water droplets resulting from dew condensation can be suppressed from adhering to the positive electrode terminals and the negative electrode terminals. Therefore, even when a plurality of coolers are used, a short circuit in the power storage device can be suppressed from occurring due to water droplets generated by dew condensation in the coolers.

Preferably, each of the battery cells has a first surface serving as a bottom surface. The second cooler is located below the first surface and is in contact with the first surface directly or with the thermally conductive member interposed therebetween.

According to the above-described configuration, the second cooler is located below each battery cell. Thus, even when water droplets generated in the second cooler due to dew condensation fall down, the water droplets do not hit each battery cell. Therefore, a short circuit between the terminals can be prevented from occurring due to water droplets generated in the second cooler.

Preferably, the first cooler is in contact with each of the positive electrode terminals and each of the negative electrode terminals directly or with the thermally conductive member interposed therebetween.

According to the above-described configuration, even when a high current is input into or output from each battery cell, each of the positive and negative electrode terminals that are more likely to generate heat in the battery cells can be cooled, and also, water droplets resulting from dew condensation can be suppressed from adhering to each of the positive and negative electrode terminals.

Preferably, each of the battery cells further has a second surface serving as a top surface. The positive electrode terminal and the negative electrode terminal protrude upward from the second surface.

According to the above-described configuration, the first cooler can be installed on the side of the top surface of each battery cell.

Preferably, the first direction is perpendicular to a vertical direction. Each of the battery cells has a first side surface and a second side surface, each of the first side surface and the second side surface having a normal direction along a second direction perpendicular to the first direction and the vertical direction. The positive electrode terminal protrudes from the first side surface in the second direction. The negative electrode terminal protrudes from the second side surface in the second direction.

According to the above-described configuration, the distance between the positive electrode terminal and the negative electrode terminal in each battery cell can be longer than that in the case where the positive electrode terminal and the negative electrode terminal protrude from the top surface of each battery cell. Therefore, a short circuit between each positive electrode terminal and each negative electrode terminal included in the same battery cell can be suppressed from occurring due to the water droplets resulting from dew condensation.

Preferably, each of the first cooler and the second cooler serves as a cooling pipe extending in the first direction and having a flow path for refrigerant. Each of the first cooler and the second cooler has: an inner surface in contact with the refrigerant; and an outer surface opposite to the inner surface. The outer surface of the first cooler has: a first contact region in contact with each of the positive electrode terminals and each of the negative electrode terminals directly or with the thermally conductive member interposed therebetween; and a first non-contact region excluding the first contact region from the outer surface. The outer surface of the second cooler has: a second contact region in contact with each of the battery cells directly or with the thermally conductive member interposed therebetween; and a second non-contact region excluding the second contact region from the outer surface. The first non-contact region is smaller in area than the second non-contact region.

According to the above-described configuration, a portion of the first cooler's outer surface that is in contact with the gas inside the power storage device is smaller in area than a portion of the second cooler's outer surface that is in contact with the gas inside the power storage device. Therefore, as compared with the case where the above-mentioned relation regarding the areas is not established, dew condensation can be caused more preferentially on the outer surface of the second cooler while further suppressing dew condensation on the outer surface of the first cooler.

Preferably, the first cooler has a first portion and a second portion that are contiguous to each other in an outer peripheral direction of the first cooler, the first portion and the second portion each extending in the first direction. The first portion and the second portion form the flow path. At least one of the first portion and the second portion is provided with a groove portion forming the flow path. At least a part of the first portion is in contact with each of the positive electrode terminals and each of the negative electrode terminals directly or with the thermally conductive member interposed therebetween. The second portion is more distant from each of the positive electrode terminals and each of the negative electrode terminals than the first portion is. The first portion is higher in thermal conductivity than the second portion and lower in thermal conductivity than the second cooler.

According to the above-described configuration, the first portion in contact with each positive electrode terminal and each negative electrode terminal with the thermally conductive member interposed therebetween is higher in thermal conductivity than the second portion not in contact with the thermally conductive member. Therefore, as compared with the case where the thermal conductivity of the second portion is the same as or higher than the thermal conductivity of the first portion, each of the positive and negative electrode terminals can be efficiently cooled. Further, the second cooler makes it possible to suppress occurrence of dew condensation in the second portion of the first cooler.

Preferably, the first cooler is connected to a first pipe on an upstream side and connected to a second pipe on a downstream side. The first pipe is lower in thermal conductivity than the second pipe.

According to the above-described configuration, the amount of water droplets generated by dew condensation can be smaller in the first pipe on the upstream side of the first cooler than in the second pipe on the downstream side of the first cooler.

Preferably, the second cooler is connected to a third pipe on the upstream side and connected to a fourth pipe on the downstream side. The third pipe is connected to the first pipe. The fourth pipe is connected to the second pipe. The third pipe is lower in thermal conductivity than the fourth pipe.

According to the above-described configuration, the amount of water droplets generated by dew condensation can be smaller in the third pipe on the upstream side of the second cooler than in the fourth pipe on the downstream side of the second cooler. Further, refrigerant can be delivered from one path to two paths (the first pipe and the third pipe). Further, refrigerants can be merged from two paths (the second pipe and the fourth pipe) to flow into one path.

According to another aspect of the present disclosure, an electrically powered vehicle includes: a plurality of battery cells each having a positive electrode terminal and a negative electrode terminal, the plurality of battery cells being arranged side by side in a predetermined direction; and a first cooler and a second cooler, each of the first cooler and the second cooler being in contact with each of the battery cells directly or with a thermally conductive member interposed therebetween. The first cooler is located above the second cooler. The second cooler is located below each of the positive electrode terminals and each of the negative electrode terminals. The first cooler is lower in thermal conductivity than the second cooler.

According to the above-described configuration, dew condensation can be caused more preferentially in the second cooler than in the first cooler. Therefore, even when a plurality of coolers are used, a short circuit in the power storage device can be suppressed from occurring due to water droplets generated by dew condensation in the coolers.

The foregoing and other objects, features, aspects, and advantages of the present disclosure will become apparent from the following detailed description of the present disclosure when taken in conjunction with the accompanying drawings.

### BRIEF DESCRIPTION OF THE DRAWINGS

FIG. 1 is a side view of an electrically powered vehicle.

FIG. 2 is a partial cross-sectional view of a battery pack.

FIG. 3 is a top view of the battery pack.

FIG. 4 is a bottom view of the battery pack.

FIG. 5 is a diagram for illustrating a cooler.

FIG. 6 is a cross-sectional view taken along an arrow line VI-VI in FIG. 2.

FIG. 7 is a diagram showing an upper cooler in FIG. 6 and the vicinity thereof.

FIG. 8 is a diagram showing a lower cooler in FIG. 6 and the vicinity thereof.

FIG. 9 is a diagram for illustrating a modification of the cooler attached above a battery module.

FIG. 10 is a diagram for illustrating another modification of the cooler attached above the battery module.

FIG. 11 is a diagram illustrating a battery pack according to another embodiment.

FIG. 12 is a diagram for illustrating a modification of the battery pack.

### DESCRIPTION OF THE PREFERRED EMBODIMENTS

Hereinafter, embodiments of the present disclosure will be described in detail with reference to the accompanying drawings. In the embodiments described below, the same or corresponding portions are denoted by the same reference characters in the drawings, and the description thereof will not be repeated.

### First Embodiment

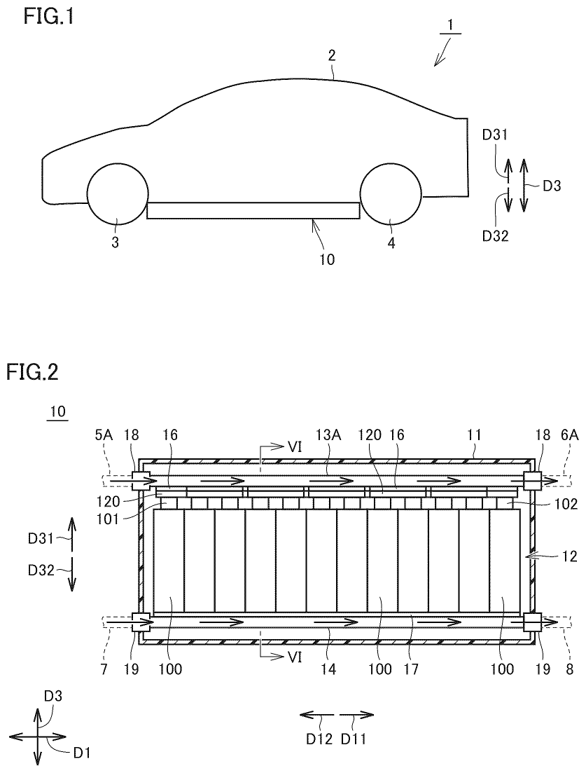

FIG. 1 is a side view of an electrically powered vehicle. As shown in FIG. 1, an electrically powered vehicle 1 includes a vehicle body 2, a front wheel 3, a rear wheel 4, and a battery pack 10. Battery pack 10 is attached to a bottom portion of vehicle body 2. Electrically powered vehicle 1 is, for example, a hybrid electric vehicle that can travel with motive power from at least one of a motor and an engine, or an electrically powered vehicle that travels with drive force obtained from electric energy. Battery pack 10 and battery packs 10A and 10B (described later) each are one example of the “power storage device” of the present disclosure.

The following describes the configuration of battery pack 10 based on the state in which battery pack 10 is attached to electrically powered vehicle 1. In other words, the direction and orientation of battery pack 10, such as upper, lower, left, right, and up and down, are defined with respect to the state in which battery pack 10 is attached to electrically powered vehicle 1 (this state will be hereinafter also referred to as an “attached state”).

In the following description, the vertical direction is referred to as a “direction D3”. The vertically upward direction is defined as an “orientation of D31”. The vertically downward direction is referred to as an “orientation of D32”.

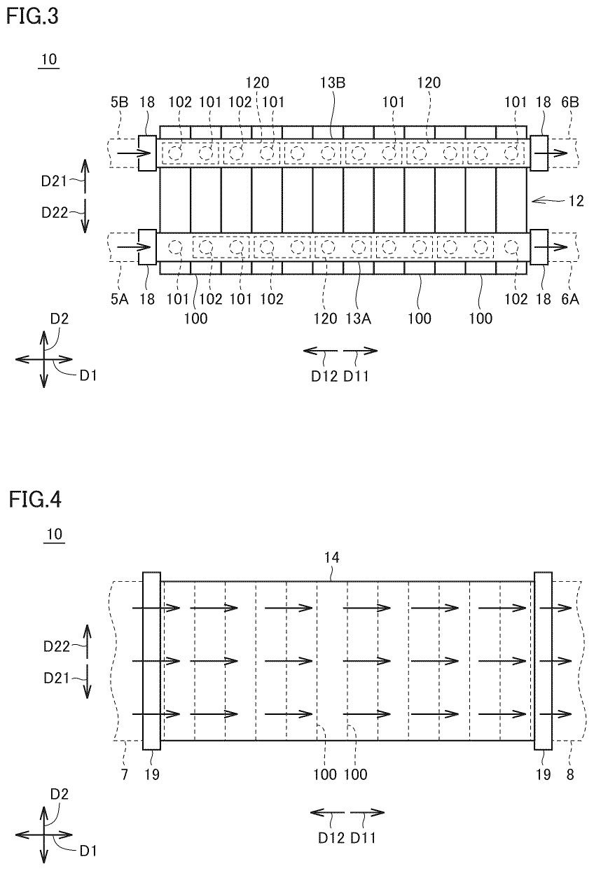

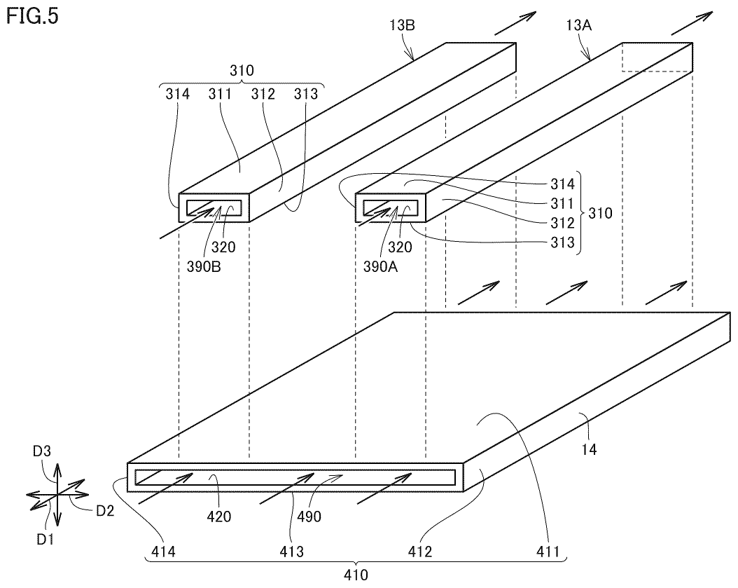

FIG. 2 is a partial cross-sectional view of battery pack 10. FIG. 3 is a top view of battery pack 10. FIG. 4 is a bottom view of battery pack 10. In FIGS. 3 and 4, an exterior case 11 described later is not shown for convenience of illustration.

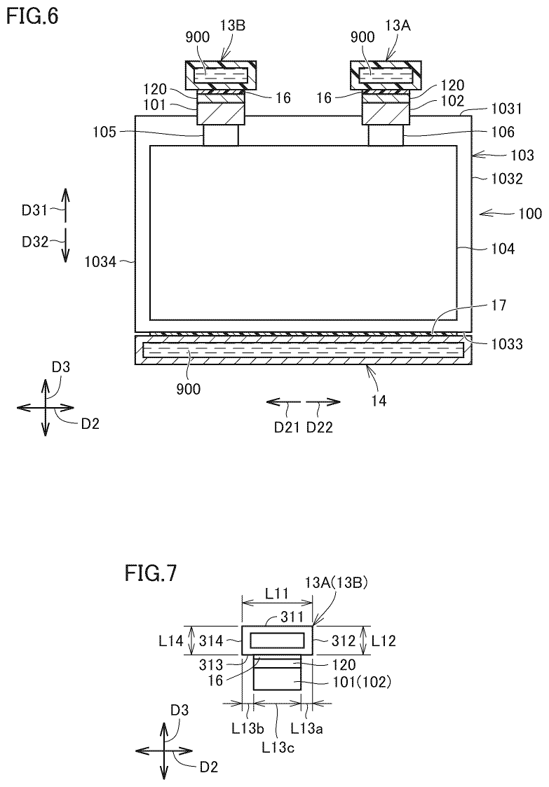

As shown in FIGS. 2 to 4, pipes 5A, 5B, 6A, 6B, 7, and 8 are connected to battery pack 10. Each of pipes 5A, 5B, 6A, 6B, 7, and 8 is an external pipe connected to battery pack 10. Aligned arrows shown in each of FIGS. 2 to 4 indicate the direction of the flow of refrigerant 900 (FIG. 6), which will be described later.

Pipes 5A, 5B, and 7 are connected to each other on the upstream side of the flow of refrigerant 900. Pipes 6A, 6B, and 8 are connected to each other on the downstream side of the flow of refrigerant 900. Thus, refrigerant 900 having flowed from the upstream side is branched to flow through pipes 5A, 5B, and 7 on the upstream side of battery pack 10, and then, flows into battery pack 10. Then, refrigerants 900 flow through pipes 6A, 6B, and 8. After that, branched refrigerants 900 flowing through the pipes merge with each other on the downstream side of battery pack 10.

Pipes 5A and 5B are lower in thermal conductivity than pipes 6A and 6B. Pipe 7 is lower in thermal conductivity than pipe 8. In the present example, pipes 5A and 5B are made of the same material. Pipes 6A and 6B are made of the same material.

Battery pack 10 includes exterior case 11, a battery module 12, coolers 13A, 13B, and 14, and connection members 18 and 19. Battery module 12 and coolers 13A, 13B, and 14 are accommodated in exterior case 11. Battery pack 10 may include a plurality of battery modules 12.

Battery module 12 includes a plurality of battery cells 100 and a plurality of bus bars 120. The plurality of battery cells 100 are arranged side by side in a direction D1. Battery cells 100 are arranged in a row. Direction D1 is orthogonal to direction D3. Direction D1 corresponds, for example, to a front-rear direction of electrically powered vehicle 1. Alternatively, direction D1 corresponds to a vehicle width direction of electrically powered vehicle 1. Direction D1 is not particularly limited as long as it is orthogonal to direction D3.

As shown in FIG. 3, each battery cell 100 has a positive electrode terminal 101 and a negative electrode terminal 102. Positive electrode terminal 101 and negative electrode terminal 102 of battery cell 100 are distant from each other in a direction D2 orthogonal to directions D1 and D3. Battery cells 100 are arranged such that positive electrode terminals 101 alternate with negative electrode terminals 102 in direction D1.

In this way, battery pack 10 has two electrode terminal rows each extending in direction D1 and spaced apart from each other in direction D2. Each electrode terminal row includes a plurality of positive electrode terminals 101 and a plurality of negative electrode terminals 102. In each of the electrode terminal rows, positive electrode terminals 101 alternate with negative electrode terminals 102. Coolers 13A and 13B are in contact with different electrode terminal rows with bus bars 120 and an adhesive layer 16 interposed therebetween.

Positive electrode terminal 101 of battery cell 100 is connected by bus bar 120 to negative electrode terminal 102 of adjacent battery cell 100 in an orientation of D11 along direction D1. Negative electrode terminal 102 of battery cell 100 is connected by bus bar 120 to positive electrode terminal 101 of adjacent battery cell 100 in an orientation of D12 along direction D1. Bus bar 120 is fixed to positive electrode terminal 101 and negative electrode terminal 102.

Note that the “orientation of D11” is directed in the same direction as that indicated by the arrows described above. In other words, the orientation of D11 corresponds to the direction in which refrigerant 900 (FIG. 6), which will be described later, flows through battery pack 10. The “orientation of D12” is opposite to the orientation of D11.

As shown in FIG. 2, cooler 13A is located above cooler 14. Cooler 13A is attached at a position higher than the position of cooler 14. As shown in FIGS. 2 and 3, cooler 13A extends in direction D1. Cooler 13A is connected to pipe 5A via connection member 18 on the upstream side of the flow of refrigerant 900. Cooler 13A is connected to pipe 6A via connection member 18 on the downstream side of the flow of refrigerant 900.

Similarly to cooler 13A, cooler 13B is located above cooler 14. Cooler 13B is attached at a position higher than the position of cooler 14. As shown in FIG. 3, similarly to cooler 13A, cooler 13B extends in direction D1. Cooler 13B is disposed in parallel to cooler 13A at a position away from cooler 13A in direction D2. Cooler 13B is connected to pipe 5B via connection member 18 on the upstream side of the flow of refrigerant 900. Cooler 13B is connected to pipe 6B via connection member 18 on the downstream side of the flow of refrigerant 900.

As shown in FIGS. 2 and 4, similarly to coolers 13A and 13B, cooler 14 extends in direction D1. Cooler 14 is disposed in parallel to coolers 13A and 13B at a position away from coolers 13A and 13B in direction D3. Cooler 14 is connected to pipe 7 via connection member 19 on the upstream side of the flow of refrigerant 900. Cooler 14 is connected to pipe 8 via connection member 19 on the downstream side of the flow of refrigerant 900.

As shown in FIGS. 2 and 3, coolers 13A and 13B are attached to battery module 12 with an adhesive. Cooler 13A is attached on the top of battery module 12 with an adhesive. Specifically, as shown in FIG. 3, coolers 13A and 13B are attached with an adhesive to the plurality of bus bars 120 arranged in a line in direction D1. More specifically, as shown in FIG. 2, coolers 13A and 13B are fixed to bus bars 120 with an adhesive layer 16 made of an adhesive. Adhesive layer 16 has insulation properties and thermal conductivity. In the present example, coolers 13A and 13B are fixed to a top surface of each bus bar 120.

When each bus bar 120 is attached to each positive electrode terminal 101 and each negative electrode terminal 102 such that the tip ends of each positive electrode terminal 101 and each negative electrode terminal 102 are exposed, coolers 13A and 13B can be brought into contact with these positive electrode terminals 101 and negative electrode terminals 102 alternately arranged in direction D1 without bus bars 120 interposed therebetween. In other words, each of coolers 13A and 13B can be brought into contact with positive electrode terminals 101 and negative electrode terminals 102 with only the adhesive layer made of an adhesive interposed therebetween. Further, each of coolers 13A and 13B may be in direct contact with positive electrode terminals 101 and negative electrode terminals 102 alternately arranged in direction D1 without bus bars 120 and adhesive layer 16 interposed therebetween.

As shown in FIGS. 2 and 3, cooler 14 is attached to battery module 12 with an adhesive. Cooler 14 is attached on the bottom of battery module 12 with an adhesive. Specifically, as shown in FIG. 4, cooler 14 is attached with an adhesive to the plurality of battery cells 100 arranged in a row in direction D1. More specifically, as shown in FIG. 2, cooler 14 is fixed to each battery cell 100 by an adhesive layer 17 made of an adhesive. Adhesive layer 17 has thermal conductivity. In the present example, the adhesive forming adhesive layer 17 is the same as the adhesive forming adhesive layer 16. However, the present disclosure is not limited thereto.

FIG. 5 is a diagram for illustrating coolers 13A, 13B, and 14. As shown in FIG. 5, coolers 13A, 13B, and 14 are tubular in shape. In other words, coolers 13A, 13B, and 14 each are a cooling pipe through which refrigerant 900 flows. In the present example, coolers 13A, 13B, and 14 each are a polygonal pipe. Specifically, coolers 13A, 13B, and 14 each are a rectangular pipe having a rectangular cross section. Note that coolers 13A and 13B each may be a square pipe having a square cross section.

According to such a configuration, a flow path 390A through which refrigerant 900 flows is formed inside cooler 13A. A flow path 390B through which refrigerant 900 flows is formed inside cooler 13B. A flow path 490 through which refrigerant 900 flows is formed inside cooler 14. In the present example, coolers 13A and 13B have the same configuration. Coolers 13A and 13B are formed in the same shape and made of the same material. However, coolers 13A and 13B do not necessarily have to have the same shape but may have different shapes.

Each of coolers 13A and 13B has an outer surface 310 and an inner surface 320. Inner surface 320 forms each of flow paths 390A and 390B. Refrigerant 900 comes into contact with inner surface 320.

Outer surface 310 includes a top surface 311, a side surface 312, a bottom surface 313, and a side surface 314. Top surface 311, side surface 312, bottom surface 313, and side surface 314 are connected in this order. The direction of the normal to top surface 311 and the direction of the normal to bottom surface 313 correspond to direction D3. The direction of the normal to side surface 312 and the direction of the normal to side surface 314 correspond to direction D2.

Adhesive layer 16 (see FIG. 2) exists between bottom surface 313 and the plurality of bus bars 120. Bottom surface 313 is bonded to the upper surfaces of the plurality of bus bars 120 with the above-mentioned adhesive.

Cooler 14 has an inner surface 420 and an outer surface 410. Inner surface 420 forms flow path 490. Refrigerant 900 comes into contact with inner surface 420. Outer surface 410 includes a top surface 411, a side surface 412, a bottom surface 413, and a side surface 414. Top surface 411, side surface 412, bottom surface 413, and side surface 414 are connected in this order. The direction of the normal to top surface 411 and the direction of the normal to bottom surface 413 correspond to direction D3. The direction of the normal to side surface 412 and the direction of the normal to side surface 414 correspond to direction D2.

Adhesive layer 17 (see FIG. 2) exists between bottom surface 413 and a bottom portion of each battery cell 100. Bottom surface 413 is bonded to a bottom surface of each battery cell 100 with the above-mentioned adhesive.

FIG. 6 is a cross-sectional view taken along an arrow line VI-VI in FIG. 2. Specifically, FIG. 6 is a cross-sectional view including: a central axis of positive electrode terminal 101 that extends in direction D3; and a central axis of negative electrode terminal 102 that extends in direction D3. As shown in FIG. 6, battery cell 100 includes an exterior case 103, an electrode assembly 104, a positive electrode tab 105, and a negative electrode tab 106, in addition to positive electrode terminal 101 and negative electrode terminal 102 as described above.

Exterior case 103 accommodates electrode assembly 104, positive electrode tab 105, and negative electrode tab 106. In the present example, an electrolyte solution is sealed inside exterior case 103. Electrode assembly 104 is, for example, a stacked electrode assembly in which positive electrodes and negative electrodes are alternately stacked with separators interposed therebetween.

Positive electrode tab 105 is connected to a positive electrode of electrode assembly 104 and positive electrode terminal 101. Negative electrode tab 106 is connected to a negative electrode of electrode assembly 104 and negative electrode terminal 102. When electrode assembly 104 is a stacked electrode assembly, each of positive electrode tab 105 and negative electrode tab 106 is constituted of a plurality of current collector foils.

Exterior case 103 includes a top surface 1031, a side surface 1032, a bottom surface 1033, and a side surface 1034. Top surface 1031, side surface 1032, bottom surface 1033, and side surface 1034 are connected in this order. The direction of the normal to top surface 1031 and the direction of the normal to bottom surface 1033 correspond to direction D3. The direction of the normal to side surface 1032 and the direction of the normal to side surface 1034 correspond to direction D2.

Side surfaces 1032 and 1034 each are a part of the outer peripheral surface of exterior case 103. The outer peripheral surface is also a part of the outer peripheral surface of battery cell 100. The outer peripheral surface is contiguous to top surface 1031 and bottom surface 1033. The outer peripheral surface includes four side surfaces. Among these four side surfaces, two side surfaces (not shown) excluding side surfaces 1032 and 1034 has a normal direction along direction D1 and face each other with electrode assembly 104 interposed therebetween.

Positive electrode terminal 101 and negative electrode terminal 102 protrude from exterior case 103 in the orientation of D31. Positive electrode terminal 101 and negative electrode terminal 102 protrude upward from top surface 1031.

In the present example, coolers 13A and 13B are located above positive electrode terminal 101 and negative electrode terminal 102. Cooler 14 is located below positive electrode terminal 101 and negative electrode terminal 102. In this way, positive electrode terminal 101 and negative electrode terminal 102 are located below coolers 13A and 13B, and cooler 14 is located below positive electrode terminal 101 and negative electrode terminal 102.

Bus bar 120 is located above positive electrode terminal 101 and negative electrode terminal 102. Coolers 13A and 13B are fixed to an upper surface of bus bar 120 with an adhesive. Thus, adhesive layer 16 exists between bus bar 120 and each of coolers 13A and 13B. Cooler 14 is fixed to bottom surface 1033 of exterior case 103 with an adhesive. Thus, adhesive layer 17 exists between cooler 14 and bottom surface 1033. As described above, refrigerant 900 flows through coolers 13A, 13B, and 14.

As described above, in the state in which at least battery pack 10 is attached to electrically powered vehicle 1, coolers 13A and 13B are located above cooler 14. Coolers 13A and 13B are made of a material different from the material of cooler 14. Coolers 13A and 13B are lower in thermal conductivity than cooler 14. The thermal conductivity of each of coolers 13A, 13B, and 14 more specifically means the thermal conductivity of a non-contact region (specifically, non-contact regions Q1 and Q2 described later) in each of coolers 13A, 13B, and 14.

In the present example, coolers 13A and 13B are made of resin. The thermal conductivity of polyamide (6 nylon) (PA) as one type of resin at 20° C. is 0.25 W/(m·K). Cooler 14 is made of aluminum (Al). The thermal conductivity of aluminum at 27° C. is 237.0 W/(m·K). The method of measuring the thermal conductivity is not particularly limited, and the thermal conductivity can be measured by known methods.

The material of coolers 13A and 13B is not limited to resin. For example, coolers 13A and 13B may be made of rubber. Similarly, the material of cooler 14 is not limited to aluminum. For example, cooler 14 may be made of other metals such as iron or steel use stainless (SUS).

The thermal conductivity of natural rubber (with a density of 0.991 g/cm³) as one type of rubber at 20° C. is 0.13 W/(m·K). The thermal conductivity of iron at 27° C. is 80.3 W/(m·K). The thermal conductivity of stainless steel (SUS304) at 27° C. is 16.0 W/(m·K). Cooler 14 is preferably made of aluminum rather than iron and stainless steel in terms of thermal conductivity and weight.

Tin (Sn) and aluminum are different in thermal conductivity by a maximum of about four times. In the case where coolers 13A and 13B and cooler 14 each are made of metal, coolers 13A and 13B may be made of metal having relatively low thermal conductivity such as tin, and cooler 14 may be made of metal having relatively high thermal conductivity such as aluminum.

The difference in thermal conductivity between cooler 14 and each of coolers 13A and 13B is preferably 50.0 W/(m·K) or more at a prescribed temperature. The difference in thermal conductivity is more preferably 200.0 W/(m·K) or more at a prescribed temperature. The prescribed temperature is preferably an environmental temperature around the power storage device. The prescribed temperature is preferably, for example, within a range of 5° C. or higher and 80° C. or lower. The prescribed temperature may be within a range of 20° C. or higher and 80° C. or lower, and is further preferably within a range of 20° C. or higher and 60° C. or lower.

Outer surface 310 of cooler 13A has: a contact region (hereinafter also referred to as a “contact region P1”) in contact with positive electrode terminal 101 and negative electrode terminal 102 with adhesive layer 16 and bus bar 120 interposed therebetween; and a non-contact region (hereinafter also referred to as a “non-contact region Q1”) excluding contact region P1 from outer surface 310. Outer surface 310 of cooler 13B also has contact region P1 and non-contact region Q1.

Outer surface 410 of cooler 14 has: a contact region (hereinafter also referred to as a “contact region P2”) in contact with each battery cell 100 with adhesive layer 17 interposed therebetween; and a non-contact region (hereinafter also referred to as a “non-contact region Q2”) excluding contact region P2 from outer surface 410.

The total sum of the area of non-contact region Q1 on outer surface 310 of cooler 13A and the area of non-contact region Q1 on outer surface 310 of cooler 13B is smaller than the area of non-contact region Q2 on outer surface 310 of cooler 14. In other words, the following equation (1) is satisfied.

2×Q1<Q2 (1)

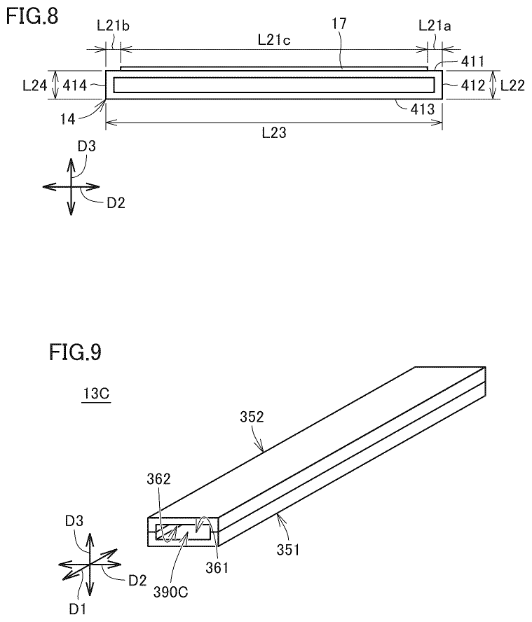

FIG. 7 is a diagram showing cooler 13A in FIG. 6 and the vicinity thereof. FIG. 8 is a diagram showing cooler 14 in FIG. 6 and the vicinity thereof.

As shown in FIG. 7, the length of top surface 311 in direction D2 is defined as L11. The length of side surface 312 in direction D3 is defined as L12. Of the length of bottom surface 313 in direction D2, the length of a portion exposed to the outside is equal to the total value of L13a and L13b. Of the length of bottom surface 313 in direction D2, the length of a portion not exposed to the outside is defined as L13c. L13c corresponds to the diameter of positive electrode terminal 101 or negative electrode terminal 102. The length of side surface 314 in direction D3 is defined as L14. Note that L12 and L14 are the same value. The total sum of L13a, L13b, and L13c is equal to L11. Cooler 13B also has the same dimensions as those of cooler 13A.

Of the length of top surface 411 in direction D2, the length of a portion exposed to the outside is equal to the total value of L21a and L21b. Of the length of top surface 411 in direction D2, the length of a portion not exposed to the outside is defined as L21c. The length of side surface 412 in direction D3 is defined as L22. The length of bottom surface 413 in direction D2 is defined as L23. The length of side surface 414 in direction D3 is defined as L24. L22 and L24 are the same value. The total sum of L21a, L21b, and L21c is equal to L23.

Similarly to the manner in which the above-mentioned equation (1) is satisfied, the following equation (2) is satisfied for each of the above-mentioned dimensions in the present example.

2×(L11+L12+L13a+L13b+L14)<L21a+L21b+L22+L23+L24 (2)

The following describes the above-mentioned equation (2) with reference to the peripheral length (the outer peripheral length) of outer surface 310 and the peripheral length of outer surface 410. The peripheral length of outer surface 310 of each of coolers 13A and 13B is defined as L10. The peripheral length of outer surface 310 of cooler 14 is defined as L20. Note that L10 is represented by the following equation (3). L20 is represented by the following equation (4).

L10=L11+L12+L13a+L13b+L13c+L14 (3)

L20=L21a+L21b+L21c+L22+L23+L24 (4)

Of peripheral length L10 of cooler 13A, the length of a portion exposed to the outside is represented by L10-L13c. Of peripheral length L10 of cooler 13B, the length of a portion exposed to the outside is also represented by L10-L13c. Of peripheral length L20 of cooler 14, the length of a portion exposed to the outside is represented by L20-L21c. In this case, the following equation (5) is satisfied for L10 and L20.

2×(L10−L13c)<L20−L21c (5)

### SUMMARY

The following is a summary of battery pack 10. Note that battery pack 10 is summarized based on the state in which battery pack 10 is attached to electrically powered vehicle 1 as described above. Further, for convenience of description, coolers 13A and 13B are hereinafter also collectively referred to as a “cooler 13”. Pipes 5A and 5B are also collectively referred to as a “pipe 5”. Similarly, pipes 6A and 6B are also collectively referred to as a “pipe 6”. Flow paths 390A and 390B are also collectively referred to as a “flow path 390”.

(1) As shown in FIG. 2, battery pack 10 includes: a plurality of battery cells 100 each having positive electrode terminal 101 and negative electrode terminal 102, the plurality of battery cells 100 being arranged side by side in direction D1; cooler 13 in contact with each battery cell 100 with the thermally conductive member (bus bar 120 and adhesive layer 16 in the present example) interposed therebetween; and cooler 14 in contact with each battery cell 100 with the thermally conductive member (adhesive layer 17 in the present example) interposed therebetween. As shown in FIGS. 2, 5, and 6, cooler 13 is located above cooler 14. As shown in FIGS. 2 and 6, cooler 14 is located below each of positive electrode terminals 101 and each of negative electrode terminals 102. Cooler 13 is lower in thermal conductivity than cooler 14.

According to such a configuration, cooler 13 located above cooler 14 is lower in thermal conductivity than cooler 14. Dew condensation is less likely to occur in the case of lower thermal conductivity than in the case of higher thermal conductivity. Thus, dew condensation can be caused more preferentially in cooler 14 than in cooler 13. Further, cooler 14 is located below each of positive electrode terminals 101 and each of negative electrode terminals 102. Therefore, according to battery pack 10, water droplets resulting from dew condensation can be suppressed from adhering to positive electrode terminal 101 and negative electrode terminal 102. Thus, even when a plurality of coolers such as coolers 13 and 14 are used, a short circuit in battery pack 10 can be suppressed from occurring due to water droplets generated by dew condensation in the coolers. Specifically, a short circuit can be suppressed from occurring between positive electrode terminal 101 and negative electrode terminal 102 of battery cell 100. Note that the above-mentioned short circuit includes both: a short circuit between positive electrode terminal 101 and negative electrode terminal 102 between adjacent battery cells 100 (a short circuit between terminals that are not connected by bus bar 120); and a short circuit between positive electrode terminal 101 and negative electrode terminal 102 in the same battery cell 100.

(2) As shown in FIG. 6, each battery cell 100 has bottom surface 1033. Cooler 14 is located below bottom surface 1033 and is in contact with bottom surface 1033 with adhesive layer 17 interposed therebetween.

According to such a configuration, cooler 14 is located below each battery cell 100. Thus, even when water droplets generated due to dew condensation in cooler 14 (specifically, water droplets adhering to the surface of cooler 14) fall down, the water droplets do not hit each battery cell 100. Therefore, a short circuit between positive electrode terminal 101 and negative electrode terminal 102 can be prevented from occurring due to the water droplets generated in cooler 14.

(3) As shown in FIG. 2, cooler 13 is in contact with each positive electrode terminal 101 and each negative electrode terminal 102 with bus bar 120 and adhesive layer 16 interposed therebetween.

According to such a configuration, even when a high current is input into or output from each battery cell 100, positive electrode terminal 101 and negative electrode terminal 102 that are more likely to generate heat in each battery cell 100 can be cooled, and also, water droplets resulting from dew condensation can be suppressed from adhering to positive electrode terminal 101 and negative electrode terminal 102.

(4) As shown in FIG. 6, each battery cell 100 has top surface 1031. As shown in FIG. 6, positive electrode terminal 101 and negative electrode terminal 102 protrude upward from top surface 1031.

According to such a configuration, cooler 13 can be installed on the top surface 1031 side of each battery cell 100.

(5) As shown in FIG. 5, cooler 13 serves as a cooling pipe extending in direction D1 and having flow path 390 for refrigerant 900. Cooler 14 serves as a cooling pipe extending in direction D1 and having flow path 490 for refrigerant 900. Cooler 13 has inner surface 320 in contact with refrigerant 900 and outer surface 310 opposite to inner surface 320. Cooler 14 has inner surface 420 in contact with refrigerant 900 and outer surface 410 opposite to inner surface 420.

Outer surface 310 of cooler 13 has: contact region P1 in contact with positive electrode terminal 101 and negative electrode terminal 102 with bus bar 120 and adhesive layer 16 interposed therebetween; and non-contact region Q1 excluding contact region P1 from outer surface 310. Outer surface 410 of cooler 14 has: contact region P2 in contact with each battery cell 100 with adhesive layer 17 interposed therebetween; and non-contact region Q2 excluding contact region P2 from outer surface 410. Non-contact region Q1 is smaller in area than non-contact region Q2.

According to such a configuration, a portion of outer surface 310 of cooler 13 that is in contact with the gas inside battery pack 10 is smaller in area than a portion of outer surface 410 of cooler 14 that is in contact with the gas inside battery pack 10. Therefore, as compared with the case where the above-mentioned relation regarding the areas is not established, dew condensation can be caused more preferentially on the outer surface of cooler 14 while further suppressing dew condensation on the outer surface of cooler 13.

(6) As shown in FIGS. 2 and 3, cooler 13 is connected to pipe 5 on the upstream side, and connected to pipe 6 on the downstream side. Pipe 5 is lower in thermal conductivity than pipe 6.

According to such a configuration, the amount of water droplets generated by dew condensation can be smaller in pipe 5 on the upstream side of cooler 13 than in pipe 6 on the downstream side of cooler 13.

(7) As shown in FIGS. 2 to 4, cooler 14 is connected to pipe 7 on the upstream side and connected to pipe 8 on the downstream side. Pipe 7 is connected to pipe 5. Pipe 8 is connected to pipe 6. Pipe 7 is lower in thermal conductivity than pipe 8.

According to such a configuration, the amount of water droplets generated by dew condensation can be smaller in pipe 7 on the upstream side of cooler 14 than in pipe 8 on the downstream side of cooler 14. Further, refrigerant 900 can be delivered from one path to two paths (pipes 5 and 7). Further, refrigerants 900 can be merged from two paths (pipes 6 and 8) to flow into one path.

### <Modifications>

### (First Modification)

FIG. 9 is a diagram for illustrating a modification of coolers 13A and 13B attached above battery module 12. As shown in FIG. 9, a cooler 13C as a modification of coolers 13A and 13B includes first portion 351 and second portion 352. In the present modification, two coolers 13C are used in place of coolers 13A and 13B.

Cooler 13C is equal in size and shape to coolers 13A and 13B. First portion 351 and second portion 352 are connected to each other in the outer peripheral direction of cooler 13C, and each extend in direction D1. Every portion in each of coolers 13A and 13B mentioned above is made of the same material. In contrast, in cooler 13C, first portion 351 and second portion 352 are made of different materials.

First portion 351 is provided with a groove portion 361. Second portion 352 is provided with a groove portion 362. First portion 351 and second portion 352 are superimposed on one another in direction D3 such that first portion 351 is located below second portion 352. First portion 351 and second portion 352 are superimposed on one another in direction D3 such that groove portions 361 and 362 are contiguous to each other in direction D3. Typically, first portion 351 and second portion 352 are fixed to each other with an adhesive. Without being limited thereto, cooler 13C may be integrally formed.

First portion 351 and second portion 352 form a flow path 390C. Groove portions 361 and 362 form flow path 390C.

At least a part of first portion 351 is in contact with positive electrode terminal 101 and negative electrode terminal 102 with the thermally conductive member (bus bar 120 and adhesive layer 16) interposed therebetween. Second portion 352 is more distant from positive electrode terminal 101 and negative electrode terminal 102 than first portion 351 is. First portion 351 is higher in thermal conductivity than second portion 352 and lower in thermal conductivity than cooler 14.

According to such a configuration, first portion 351 in contact with positive electrode terminal 101 and negative electrode terminal 102 with bus bar 120 and adhesive layer 16 interposed therebetween is higher in thermal conductivity than second portion 352 not in contact with bus bar 120 and adhesive layer 16. Thus, as compared with the case where the thermal conductivity of second portion 352 is the same as or higher than the thermal conductivity of first portion 351, positive electrode terminal 101 and negative electrode terminal 102 can be efficiently cooled. Further, cooler 14 makes it possible to suppress occurrence of dew condensation in second portion 352 of cooler 13C.

In the example of the configuration described above, first portion 351 and second portion 352 have groove portion 361 and groove portion 362, respectively, but the present disclosure is not limited thereto. At least one of first portion 351 and second portion 352 may be provided with a groove portion forming flow path 390C. First portion 351 may be in direct contact with positive electrode terminal 101 and negative electrode terminal 102 without bus bar 120 and adhesive layer 16 interposed therebetween. Alternatively, first portion 351 may be in contact with positive electrode terminal 101 and negative electrode terminal 102 with only an adhesive layer 16 interposed therebetween.

### (Second Modification)

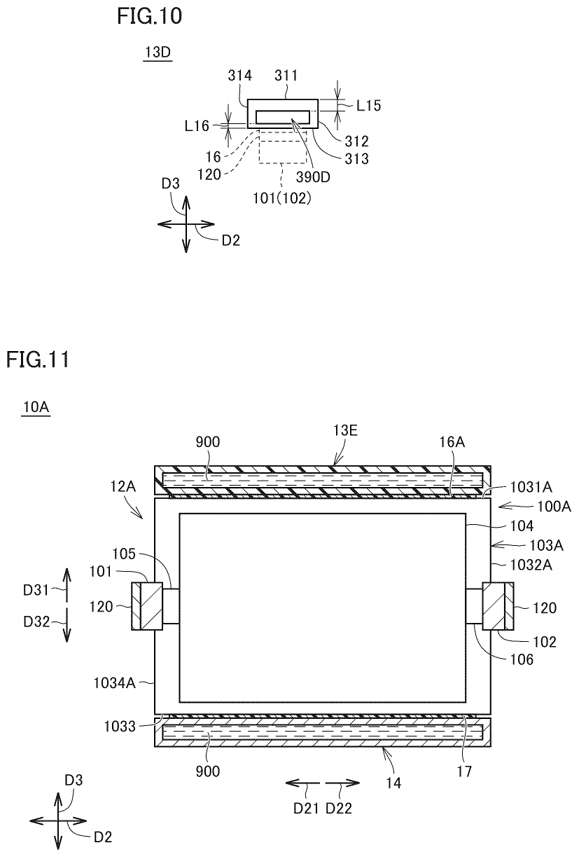

FIG. 10 is a diagram for illustrating another modification of coolers 13A and 13B attached above battery module 12. As shown in FIG. 10, a cooler 13D is provided with a flow path 390D.

In cooler 13D, the position of flow path 390D is different from those of flow paths 390A and 390B in coolers 13A and 13B. The position of flow path 390D in cooler 13D in direction D3 is lower than the positions of flow paths 390A and 390B in coolers 13A and 13B in direction D3. Thus, in cooler 13D, the thickness (L16) on the bottom surface 313 side is smaller than the thickness (L15) on the top surface 311 side. Except for this point, cooler 13D has the same configuration as those of coolers 13A and 13B.

Even such a configuration makes it possible to achieve the same effect as that achieved in the case of using cooler 13C described with reference to FIG. 9.

### Second Embodiment

The following describes a battery pack that is different in configuration from battery pack 10 in the first embodiment. FIG. 11 is a diagram illustrating a battery pack according to the present embodiment. FIG. 11 is a cross-sectional view taken along the arrow line at the same position as that in FIG. 6.

As shown in FIG. 11, battery pack 10A includes a battery module 12A, a cooler 13E, and cooler 14. Battery module 12A includes a plurality of battery cells 100A. Battery pack 10A is different from battery pack 10 in the first embodiment in that it has battery module 12A in place of battery module 12, and has cooler 13E in place of coolers 13A and 13B.

Battery cell 100A includes positive electrode terminal 101, negative electrode terminal 102, an exterior case 103A, electrode assembly 104, positive electrode tab 105, and negative electrode tab 106. Exterior case 103A accommodates electrode assembly 104, positive electrode tab 105, and negative electrode tab 106. In the present example, an electrolyte solution is sealed inside exterior case 103A. Positive electrode tab 105 is connected to a positive electrode of electrode assembly 104 and positive electrode terminal 101. Negative electrode tab 106 is connected to a negative electrode of electrode assembly 104 and negative electrode terminal 102.

Exterior case 103A includes a top surface 1031A, a side surface 1032A, a bottom surface 1033, and a side surface 1034A. Top surface 1031A, side surface 1032A, bottom surface 1033, and side surface 1034A are connected in this order.

Side surfaces 1032A and 1034A each are a part of the outer peripheral surface of exterior case 103A. The outer peripheral surface is also a part of the outer peripheral surface of battery cell 100. The outer peripheral surface is contiguous to top surface 1031A and bottom surface 1033. As in the first embodiment, the outer peripheral surface includes four side surfaces.

Positive electrode terminal 101 and negative electrode terminal 102 protrude from exterior case 103A in direction D2. Specifically, in battery cell 100A shown in FIG. 11, positive electrode terminal 101 protrudes from exterior case 103A in an orientation of D21. Positive electrode terminal 101 protrudes from side surface 1034A in direction D2. Negative electrode terminal 102 protrudes from exterior case 103A in an orientation of D22. Negative electrode terminal 102 protrudes from side surface 1032A in direction D2. Bus bar 120 is located on the lateral side of each of positive electrode terminal 101 and negative electrode terminal 102. In the present example, no adhesive layer exists between cooler 13E and bus bar 120.

Cooler 13E is located above cooler 14. Cooler 14 is located below positive electrode terminal 101 and negative electrode terminal 102. In the present example, cooler 13E is equal in size and shape to cooler 14. However, the present disclosure is not limited thereto. For example, cooler 13E may be shorter in length (width) in direction D2 than cooler 14.

Coolers 13E and 14 are made of different materials. In the present example, cooler 13E is made of the same material as that of coolers 13A and 13B. Thus, cooler 13E is lower in thermal conductivity than cooler 14.

Cooler 13E is attached on the top of battery module 12A. Cooler 13E is located above each battery cell 100A. Cooler 13E is fixed to top surface 1031A of exterior case 103 with an adhesive. Thus, adhesive layer 16A exists between cooler 13E and top surface 1031A. Refrigerant 900 flows through cooler 13E.

As described above, in the state in which at least battery pack 10A is attached to electrically powered vehicle 1, cooler 13E is located above cooler 14. Cooler 14 is located below positive electrode terminal 101 and negative electrode terminal 102. Cooler 13E is lower in thermal conductivity than cooler 14. Thus, similarly to battery pack 10 in the first embodiment, battery pack 10A makes it possible to suppress water droplets generated by dew condensation from adhering to positive electrode terminal 101 and negative electrode terminal 102. Therefore, even when a plurality of coolers such as coolers 13E and 14 are used, a short circuit between positive electrode terminal 101 and negative electrode terminal 102 of battery cell 100A can be suppressed from occurring due to water droplets generated by dew condensation in the coolers.

Each battery cell 100A has two side surfaces 1032A and 1034A, each of side surfaces 1032A and 1034A having a normal direction along direction D2 perpendicular to directions D1 and D3 in the state in which battery pack 10A is attached to electrically powered vehicle 1. Positive electrode terminal 101 protrudes from side surface 1034A in direction D2. Negative electrode terminal 102 protrudes from side surface 1032A in direction D2.

According to such a configuration, the distance between positive electrode terminal 101 and negative electrode terminal 102 in each battery cell 100 can be longer than that in the case where positive electrode terminal 101 and negative electrode terminal 102 protrude from top surface 1031 of battery cell 100 as in FIG. 6. Therefore, a short circuit resulting from water droplets generated by dew condensation can be suppressed from occurring between positive electrode terminal 101 and negative electrode terminal 102 included in the same battery cell 100.

### <Modifications>

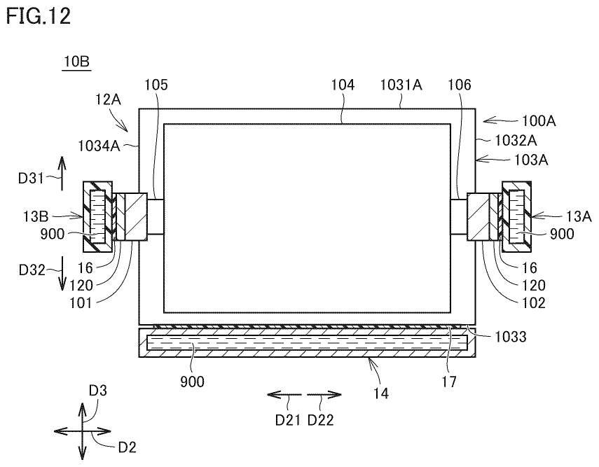

FIG. 12 is a diagram for illustrating a modification of battery pack 10A. As shown in FIG. 12, battery pack 10B includes battery module 12A and coolers 13A, 13B, and 14. Battery pack 10B is different from battery pack 10A in that it includes coolers 13A and 13B in place of cooler 13E.

As compared with battery pack 10 in the first embodiment that includes coolers 13A and 13B, in battery pack 10B, the positions of positive electrode terminal 101 and negative electrode terminal 102 of battery cell 100A are different from the positions of positive electrode terminal 101 and negative electrode terminal 102 of battery cell 100 shown in FIG. 6. Thus, the positions of coolers 13A and 13B in battery pack 10B are also different from those of coolers 13A and 13B in battery pack 10.

Specifically, in battery pack 10B, coolers 13A and 13B are located above cooler 14, as in battery pack 10 in the first embodiment. Cooler 14 is located below positive electrode terminal 101 and negative electrode terminal 102. Coolers 13A and 13B each are attached to battery module 12A with an adhesive. Cooler 13A is attached to a side portion of battery module 12A with an adhesive. Specifically, coolers 13A and 13B are attached with an adhesive to a plurality of bus bars 120 arranged in a row in direction D1. More specifically, coolers 13A and 13B are fixed to bus bar 120 with adhesive layer 16 made of an adhesive.

Such a configuration also allows a longer distance between positive electrode terminal 101 and negative electrode terminal 102 in each battery cell 100. Therefore, a short circuit caused by dew condensation between positive electrode terminal 101 and negative electrode terminal 102 can be further suppressed. Further, positive electrode terminal 101 and negative electrode terminal 102 that are more likely to generate heat can be efficiently cooled.

In the above-described example, battery pack 10, 10A, or 10B is attached to an electrically powered vehicle (specifically, electrically powered vehicle 1), but the target to which battery pack 10, 10A, or 10B is attached is not limited to the electrically powered vehicle.

Although the embodiments of the present disclosure have been described, it should be understood that the embodiments disclosed herein are illustrative and not restrictive in every respect. The scope of the present disclosure is defined by the terms of the claims, and is intended to include any modifications within the meaning and scope equivalent to the terms of the claims.

What is claimed is:

1. A power storage device comprising:
a plurality of battery cells each having a positive electrode terminal and a negative electrode terminal, the plurality of battery cells being arranged side by side in a first direction; and
a first cooler and a second cooler, each of the first cooler and the second cooler being in contact with each of the battery cells directly or with a thermally conductive member interposed therebetween, wherein
the first cooler is located above the second cooler, and the second cooler is located below each of the positive electrode terminals and each of the negative electrode terminals, and
the first cooler is lower in thermal conductivity than the second cooler.

2. The power storage device according to claim 1, wherein
each of the battery cells has a first surface serving as a bottom surface, and
the second cooler is located below the first surface and is in contact with the first surface directly or with the thermally conductive member interposed therebetween.

3. The power storage device according to claim 2, wherein the first cooler is in contact with each of the positive electrode terminals and each of the negative electrode terminals directly or with the thermally conductive member interposed therebetween.

4. The power storage device according to claim 3, wherein
each of the battery cells further has a second surface serving as a top surface, and
the positive electrode terminal and the negative electrode terminal protrude upward from the second surface.

5. The power storage device according to claim 3, wherein
the first direction is perpendicular to a vertical direction,
each of the battery cells has a first side surface and a second side surface, each of the first side surface and the second side surface having a normal direction along a second direction perpendicular to the first direction and the vertical direction,
the positive electrode terminal protrudes from the first side surface in the second direction, and
the negative electrode terminal protrudes from the second side surface in the second direction.

6. The power storage device according to claim 3, wherein
each of the first cooler and the second cooler
serves as a cooling pipe extending in the first direction and having a flow path for refrigerant, and
has an inner surface in contact with the refrigerant and an outer surface opposite to the inner surface,
the outer surface of the first cooler has
a first contact region in contact with each of the positive electrode terminals and each of the negative electrode terminals directly or with the thermally conductive member interposed therebetween, and
a first non-contact region excluding the first contact region from the outer surface,
the outer surface of the second cooler has
a second contact region in contact with each of the battery cells directly or with the thermally conductive member interposed therebetween, and
a second non-contact region excluding the second contact region from the outer surface, and
the first non-contact region is smaller in area than the second non-contact region.

7. The power storage device according to claim 6, wherein
the first cooler has a first portion and a second portion that are contiguous to each other in an outer peripheral direction of the first cooler, the first portion and the second portion each extending in the first direction,
the first portion and the second portion form the flow path,
at least one of the first portion and the second portion is provided with a groove portion forming the flow path,
at least a part of the first portion is in contact with each of the positive electrode terminals and each of the negative electrode terminals directly or with the thermally conductive member interposed therebetween,
the second portion is more distant from each of the positive electrode terminals and each of the negative electrode terminals than the first portion is, and
the first portion is higher in thermal conductivity than the second portion and lower in thermal conductivity than the second cooler.

8. The power storage device according to claim 1, wherein
the first cooler is connected to a first pipe on an upstream side and connected to a second pipe on a downstream side, and
the first pipe is lower in thermal conductivity than the second pipe.

9. The power storage device according to claim 8, wherein
the second cooler is connected to a third pipe on the upstream side and connected to a fourth pipe on the downstream side,
the third pipe is connected to the first pipe,
the fourth pipe is connected to the second pipe, and
the third pipe is lower in thermal conductivity than the fourth pipe.

10. An electrically powered vehicle comprising:
a plurality of battery cells each having a positive electrode terminal and a negative electrode terminal, the plurality of battery cells being arranged side by side in a predetermined direction; and
a first cooler and a second cooler, each of the first cooler and the second cooler being in contact with each of the battery cells directly or with a thermally conductive member interposed therebetween, wherein
the first cooler is located above the second cooler,
the second cooler is located below each of the positive electrode terminals and each of the negative electrode terminals, and
the first cooler is lower in thermal conductivity than the second cooler.
